(19) United States
(12) Patent Application Publication
(10) Pub. No.: US 2011/0238482 A1
(43) Pub. Date: Sep. 29, 2011

(54) Digital Profile System of Personal Attributes, Tendencies, Recommended Actions, and Historical Events with Privacy Preserving Controls

(76) Inventors: John S. Carney, Alexandria, VA (US); Brian D. Duffy, Washington, DC (US)

(21) Appl. No.: 12/749,369

(22) Filed: Mar. 29, 2010

(51) Int. Cl. G06F 17/30; G06F 12/14; G06Q 30/00; G06Q 20/00; G06Q 50/00

(52) U.S. Cl. 705/14.36; 707/752; 707/802; 707/722; 713/189; 707/E17.044; 707/E17.005; 707/783; 707/754; 707/769; 707/E17.014

(57) ABSTRACT

Embodiments of the invention provide a digital profile system for a user and a method for capturing, storing, and updating information about a user's attributes in a personal genome database. The system interacts with a third-party application which provides an assessment tool for execution by the user. The system includes the personal genome database, a server processor which executes computer-readable instructions of an advanced competency model, a unique pass code system, and at least one privacy filter, and a user processor which executes computer-readable instructions of a client manager.

### BACKGROUND

Detailed user models for commercial and academic purposes have existed for some time, but the vast majority of these user models have been constructed and maintained by the organizations that intend to use the data. The data is owned by entities other than the individual whom the data describes. Moreover, many different organizations maintain separate user models of the same individuals, which leads to wide scale replication of personal data and generally incomplete representations of individuals. To date, there has been no successful effort to construct a centralized clearinghouse of personal data that is both easily accessible by organizations who need to access it and secure enough to allow individuals to remain in complete control of their own data and preserve their privacy where desired.

### SUMMARY

Some embodiments of the invention provide a digital profile system for a user. The system interacts with a third-party application which provides an assessment tool for execution by the user. The system includes a personal genome database which stores a plurality of user attributes, the plurality of user attributes being associated with a private user identifier and a server processor which executes computer-readable instructions of an advanced competency model to define and sort the plurality of user attributes to designated slots in the personal genome database. The server processor also executes computer-readable instructions of a unique pass code system to generate a current temporary pass code and link the current temporary pass code to the private user identifier and the plurality of user attributes associated with the private user identifier, and at least one privacy filter to apply data access privileges to the third-party application based on privacy filtering rules controlled by the user. The system also includes a user processor in communication with the server processor. The user processor executes computer-readable instructions of a client manager to receive a request from the third-party application for the current temporary pass code, retrieve and submit the current temporary pass code to the third-party application, receive a request from the third-party application for the plurality of user attributes for adapting the assessment tool specifically for the user, retrieve and submit the plurality of user attributes to the third-party application if allowed by the at least one privacy filter, receive an updated attribute from the third-party application based on the user's performance when executing the assessment tool, and submit the updated attribute to the advanced competency model to define and sort the updated attribute to a designated slot in the personal genome.

Some embodiments of the invention provide a method for capturing, storing, and updating information about a user's attributes in a personal genome database in communication with a user computer. The method includes providing a first personalized assessment instrument for execution by the user, retrieving an outcome of the first personalized assessment instrument executed by the user, and mapping the outcome to at least one attribute of the user. The method also includes updating information for the at least one attribute in accordance with the outcome, storing the information for the at least one attribute in the personal genome database, and providing the information to an application, when authorized by the user, for creating a second personalized assessment instrument for execution by the user.

### DESCRIPTION OF THE DRAWINGS

FIG. 1 is a block diagram of a system according to one embodiment of the invention.

FIG. 2 is a communications flow diagram for a system according to one embodiment of the invention.

FIG. 3 is a screenshot of a client manager for use with the system of some embodiment of the invention.

FIG. 4 is another screenshot of the client manager.

FIG. 5 is a screenshot of a data form used with the client manager.

FIG. 6 is a flowchart illustrating a process for third-party access to personal genome data of the system.

FIG. 7 is a flowchart illustrating a process for pass code mapping within the system.

FIG. 8 is a flowchart illustrating a process for registering a new assessment instrument with the system.

FIG. 9 is a flowchart illustrating a process for data encryption within the system.

FIG. 10A is a block diagram describing relationships between a user and different activities.

FIG. 10B is another block diagram of relationships between a user and different activities referencing an advanced competency model of the system.

FIG. 10C is another block diagram of conventional relationships between a user and different activities.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

For the purposes of this disclosure a computer-readable medium stores computer data, which data can include computer program code that is executable by a computer, in machine readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer-readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Some embodiments of the invention provide a comprehensive, universally accessible digital profile system that can capture, organize, store, and distribute detailed information about participating users in a secure manner. The system can form a detailed centralized user model that fully describes a wide variety of personal attributes for each participating user, such as demographics, physical characteristics, personality traits, interests, attitudes, aptitudes, skills, competencies, activities, recommended actions, and historical events. The system can provide an authorized third-party application access to portions of the user's information when needed while still preserving the user's privacy. The system can be fully dynamic and automatically expandable such that virtually any type of data can be captured and later aggregated to adapt to a user's permissions and/or privacy settings.

Authorized third-party data consumers, or third-party applications, can access users' data via a special pass code scheme, however users can maintain control over their own data and can set multi-tiered privacy filters that can automatically aggregate or mask their data prior to release to specific third-party data consumers. The users can choose to opt-in or opt-out of data sharing opportunities on a case-by-case basis if desired. Each user can have a unique, private identifier, similar to the way hardware devices receive a unique IP address, that is connected to their stored data. Third-parties do not have access to the user's private identifier, however they can still have access to portions of the user's data. An intermediate, unique pass code system can interpret private identifiers and generate temporary pass codes that link portions of the user's data to the requesting third-party application for short periods of time. When the third-party application's transaction completes (e.g., the third-party application has received and/or submitted data), the temporary pass code can be voided so that the third-party application no longer has access to the user's data. Because the third-party application is kept unaware of the user's private identifier and can only access the data via the special intermediate pass code system, the system can have control over when and what kind of data can be accessed.

The pass code mapping (i.e., between user identifiers and temporary pass codes) coupled with data privacy and aggregation tools, according to some embodiments of the invention, can provide a solid, commercially viable, and reliable source of detailed user model information that gives the individual data owner the choice of when and how to share their own data. In addition, third-party applications can also be data providers, thus allowing the underlying user model to continue to grow with use. As the data grows, the accuracy of data contained with the model can continue to increase in overall accuracy.

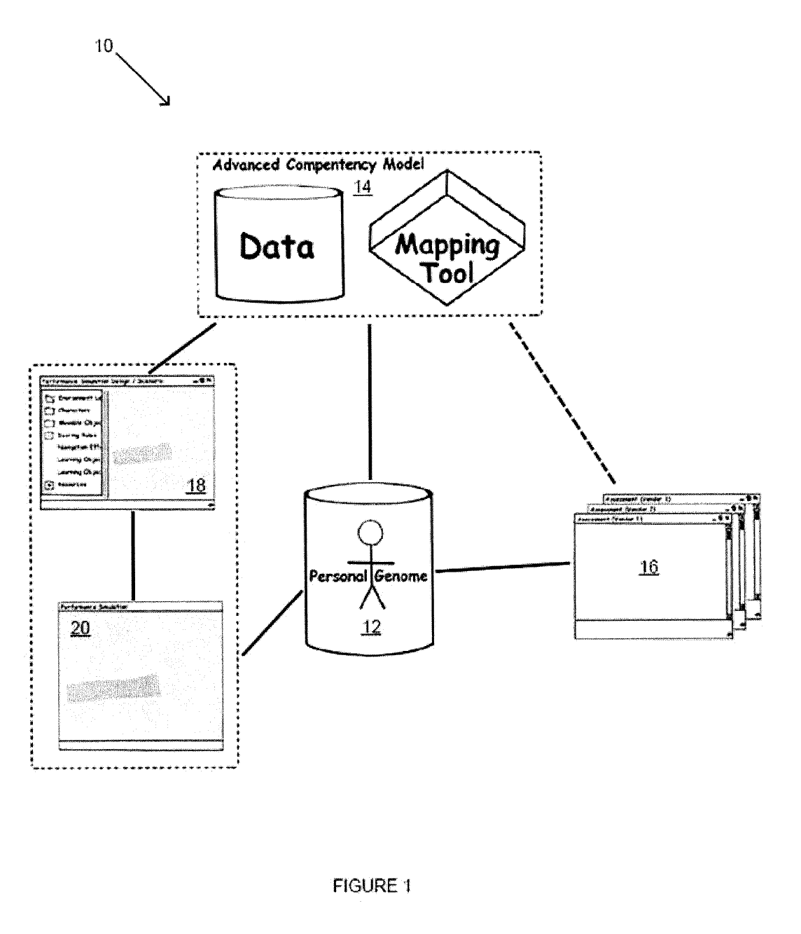

FIG. 1 illustrates a block diagram of a digital profile system 10 according to one embodiment of the invention. The system 10 can connect detailed personal attribute data with comprehensive models of a wide variety of accepted competency definitions in many different domains. As shown in FIG. 1, the system 10 can include a personal genome 12, an advanced competency model 14, assessment instruments 16, performance assessment environment design tools 18, and a performance assessment environment 20. One or more components of the system 10 can be stored on computer-readable medium, for example on one or more servers connected via a network. Processing to carry out computer-readable instructions associated with one or more components of the system 10 can be performed via processors on a central processing unit of a server computer on the one or more servers (e.g., a “server processor”), on a processor of a user's personal computer, personal digital assistant (PDA), smart phone, etc. (e.g., a “user processor”), and/or on a processing unit of a third-party application computer (e.g., an “application processor”).

In some embodiments, the personal genome 12 can be the central data component of the system 10. The personal genome 12 can act as a secure repository to store information about all aspects of a user's skills, knowledge, personality, demographics, interests, aptitudes, attitudes, and behaviors, collectively known as the user's attributes. For example, the personal genome 12 can be a secure system database on the network server. In some embodiments, the personal genome 12 can store low-level attributes, which can be combined in numerous ways to provide performance-level attributes for the rest of the system 10. Each attribute can be stored in a specific location, or assigned “slot,” in the personal genome 12. In one embodiment, a secure system database can store a multitude of personal genomes 12, each of which relating to a single individual user. In addition, different portions of users' personal genome data (i.e., the user's attributes) can be stored on several different servers using different encryption schemes to increase privacy of the users' information. A raw data gateway (not shown) can be used to split incoming data to different servers and retrieve the data when requested.

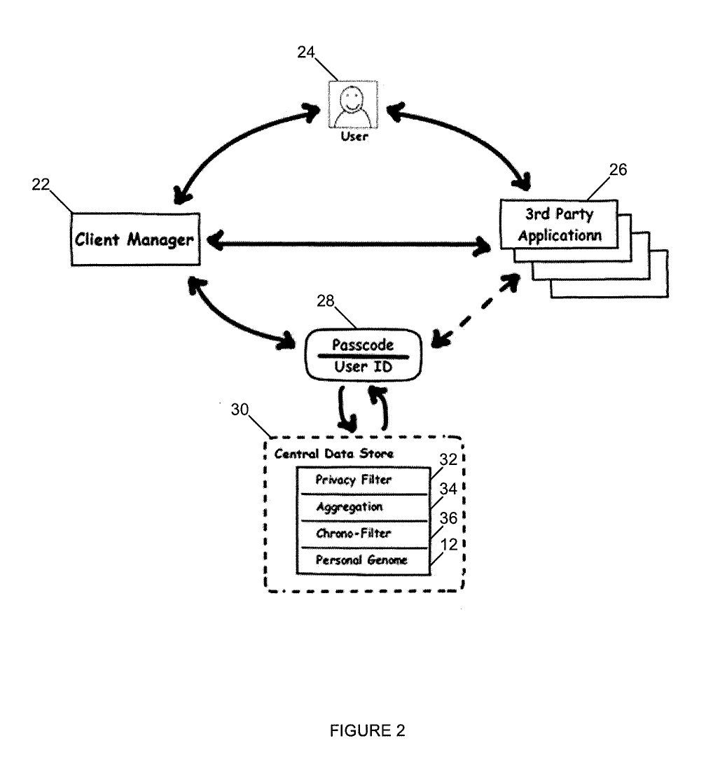

The advanced competency model 14 can be a collection of organization-specific competency definition data and an associated mapping tool that specifies the relationships between competency statements from different organizations or applications as well as enabling relations and other relations with other personal genome attributes. The advanced competency model 14 can provide the foundational language in which each user's personal attributes can be used to describe the user's current performance abilities. This same foundational language can be used to perform gap analysis tasks when comparing a user's current attributes to an accepted level of performance or job description. For example, the advanced competency model 14 can map attributes requested by or received from third-party applications 26 (illustrated in FIG. 2) to their correct slots in the personal genome 12. In one embodiment, the advanced competency model 14 is a set of computer-readable instructions and data stored on computer-readable storage media and in communication with the personal genome 12. In addition, in some embodiments, the advanced competency model 14 can include definitions that conform to the IEEE (Institute of Electrical and Electronics Engineers) Reusable Competency Definition format.

Assessment instruments 16 can be developed by third-party applications 26 and can be linked into the system 10 to update a user's personal genome data. Assessment instruments 16 can be registered with the system 10, indicating which attributes can be assessed via the specific instrument 16. For example, an assessment instrument 16 can be a questionnaire, test, game-like simulation, etc. executable by a user 24 (shown in FIG. 2) and used to evaluate or assess the user 24 on one or more specific topics (i.e., relating to specific attributes and competencies of the user 24). The system 10 can automatically accept, adapt, and accommodate incoming assessment data and/or results from the assessment instruments 16 to a central data server (as described below) and store the data and/or results in proper slots within the personal genome 12. In one embodiment, assessment instruments 16 can be computer-readable instructions stored remotely and allowed to interface with the personal genome 12 and other components of the system 10.

Third-party applications 26 can use advanced competency model data to construct performance assessment environments 20 using performance assessment environment design tools 18. The performance assessment environments 20 can leverage knowledge about a user's personal genome 12 and assess specific skills and competencies. For example, a performance assessment environment 20 can be a simulation environment, or virtual world, containing one or more assessment instruments 16 for a given field or topic.

Once designed to interact with the system 10, performance assessment environments 20 can take full advantage of user attributes available within each user's personal genome 12. The performance assessment environment design tools 18 can personalize the performance assessment environment 20 for the user. The performance assessment environment design tools 18 can query the personal genome 12 to obtain a valid starting point and then capture updated representations of the user's current abilities or attributes based on tasks that are derived from the advanced competency model 14. For example, the performance assessment environment design tools 18 can modify or delete portions of an assessment instrument 16 executed by a user based on the user's skill levels or other attributes. In one embodiment, the performance assessment environment design tools 18 and the performance assessment environments 20 are sets of computer-readable instructions stored remotely on computer-readable storage media (e.g., on a third-party server) and are in communication with each other, as well as the advanced competency model 14 and the personal genome 12. Also, in one embodiment, the system 10 can create performance enhancement environments 20 and assessment instruments 16 in addition to interacting with those created by third-party applications 26.

FIG. 2 illustrates a basic communication flow of the system 10, according to one embodiment of the invention. A client manager 22 of the system 10 can communicate with the user 24 and third-party applications 26 via operating system messages or the system's web service architecture. For example, communication can occur when the client manager 22, the user 24, and/or the third-party application 26 are connected to the network (i.e., an electronic form of communication). Other forms of communication can include visual, sound, radiofrequency identification (RFID), and physical connections. User privacy can be protected through a unique pass code system 28 that allows applications 26 to access the user's data without knowing who the user 24 is.

The user 24 can always be in control of their personal genome data. The communications process can begin with the user 24 launching the client manager 22 (either manually or automatically at system start-up), for example through an online web program or downloaded program on the user's computer (herein, the user's computer can refer to a personal computer, PDA, smart phone, etc.). The client manager 22 can send the user's ID to the pass code system 28 and receive a temporary pass code for the user 24 to provide to third-party applications 26 (i.e., rather than giving the user's actual user ID). The user 24 can then launch one or more personal genome-enabled third-party applications 26 that use the temporary pass code to gain access to the user's personal genome data without receiving knowledge of the user's actual identification and personal credentials. The third-party applications 26 can be stored directly on the user's computer, accessed via other online web programs, or accessed through other forms of communication (e.g., visual, sound, radiofrequency identification (RFID), and/or physical connections). The user 24 can revoke the temporary pass code at any time and terminate a third-party application's ability to access the user's personal genome data instantly.

The client manager 22 can be a background application on the user's computer that acts as a gatekeeper for the user's personal genome data. In addition to initiating the user ID to pass code mapping process, the client manager 22 can provide user interfaces for viewing and updating the user's personal genome data and any filtering rules that control which applications 26 can access the data and what level of aggregation should be applied for before sending the data to each third-party application 26. Different rules can be applied to the data based on exactly which application 26 is requesting the data. In some embodiments, the user interfaces can provide tools to allow the user to review, modify, and/or delete any data stored on their personal genome 12. In addition, the user interfaces can provide tools to allow the user to review, modify, and/or delete filtering and access rules for specific third-party applications 26. For example, the system 10 can provide an indexing scheme that allows the users to create profiles for different categories (e.g., attributes related to education, training, retail, fitness, museum experience, restaurant experience, etc.) so that only specific portions of the user's overall data is exposed based on the specific category required at the time.

The unique pass code system 28 can maintain a mapping between active pass codes and associated user IDs, ensuring that third-party applications 26 can access user data by invitation only. Only the temporary pass code is known to third-party applications 26, and each data access request being processed by the unique pass code system 28 automatically converts the temporary pass code to a pointer to the user's actual data. The temporary pass code can be time-sensitive in that it can have a very short lifespan and automatically time out after a period of inactivity. There can be no link between the pass code and the actual user's data beyond a period of time allocated by the user 24. As a result, any third-party application 26 or vendor (i.e., an entity that creates and/or operates one or more third-party applications 26) who receives a temporary pass code during a given session may not be able to use that temporary pass code in a later session, as controlled by the user 24. The unique pass code system 28 can be a key element to ensuring the long-term privacy of the user's personal genome data. In one embodiment, the unique pass code system 28 can produce temporary pass codes in the form of a sequence of characters (i.e., an electronic pass code). In another embodiment, the unique pass code system 28 can produce temporary pass codes in the form of a graphic representation of a unique shape (e.g., a visual pass code) that can be identified and interpreted by computer vision algorithms.

In one embodiment, the unique pass code system 28 can store pass code information in a table stored in a central data store 30 of the system 10 (shown in FIG. 2). The table can include a temporary pass code, the associated user's private ID, an expiration time, and an indicator of when the most recent activity occurred. The user 24 can change the expiration settings to different durations. An example duration time can be about 20 minutes after the most recent activity occurred. The unique pass code system 28 can continuously check the status of the temporary pass codes and revoke any temporary pass codes that have exceeded their expiration time. When a new temporary pass code is generated, the old temporary pass code can be removed (and thus nullified) and replaced with the new temporary pass code.

FIG. 2 also illustrates the central data store 30. The central data store 30 can store several layers of data, meta-data, and filtering rules that ensure that user's personal genome data is protected in a manner that directly reflects each user's specific requirements. The central data store 30 can, for example, be a secure system database that includes data layers in the form of the personal genome 12, a privacy filter 32, an aggregation filter 34, a chrono-filter 36, as well as other system data. The personal genome 12 can include the lowest-level (i.e., “raw”) data reported from the assessment instruments 16. In some embodiments, this raw data is never provided to anyone other than the user 24. However, the raw data can be temporarily modified during data requests as described below with respect to the other data layers.

The chrono-filter 36 can be a set of computer-readable instructions to invoke special time sensitive rules that impose certain degradations of assessment values in the personal genome 12 based on the specific genome data and the amount of time that has elapsed since the particular genome slot (i.e., the attribute stored in the particular slot) was last assessed. For example, complex or little used skills or knowledge can degrade over time if not periodically refreshed.

The aggregation filter 34 can be a set of computer-readable instructions to invoke rules that combine groups of genome slots into fewer, more meaningful values or shield details of a user's genome data by blurring the data into less specific values for the same genome slot. For instance, a user may wish to blur their location setting from a specific address to only report the city or state in which the user is located, thus protecting the user's privacy while still providing some level of useful data for third-party applications 26 to use. Aggregation rules can be vendor-specific or application-specific so the same data can be aggregated in different ways depending on which vendor or application 26 is requesting the data. Vendor-specific rules can apply to all third-party applications 26 owned and/or operated by the specific vendor. For example, the aggregation filter 34 can be applied to a user's demographic genome data to provide a user's postal code to third-party applications 26 from one vendor and to provide only a user's state and geographic region to third-party applications 26 from another vendor.

The privacy filter 32 can be a set of computer-readable instructions with top level filtering rules that control whether a particular vendor or application 26 can access specific genome data at all. The user 24 can specify multiple levels of privacy filter rules for each vendor and/or application 26. The privacy filter layer can also keep track of which vendor and/or application 26 has accessed particular genome slots so the user 24 can review the data access patterns to ensure that only appropriate data access requests are being attempted.

Privacy filter rules and aggregation filter rules can be associated with a vendor ID that links the filter rules to the specific vendor and its associated applications 26. In some embodiments, the aggregation filter rules and the privacy filter rules can be fixed or amended in-mass or on a case-by-base basis. With the privacy filter rules 32, the user 24 can choose an “opt-in” approach, where the system 10 restricts all vendors and third-party applications 26 from receiving the user's personal genome data until the user explicitly selects the specific vendors and applications 26 to grant them access to their personal genome data. The user 24 can also choose an “opt-out” approach, where the system 10 allows access to all vendors and third-party applications 26 until the user explicitly selects the specific vendors and applications 26 to restrict them from accessing their personal genome data. The user 24 can also choose a “prompt-to-access” approach, where the system 10 prompts the user 24 the first time a vendor attempts to access their personal genome data, and the user 24 can choose to decline the access, allow the access for the current session, or always allow access for the requesting vendor.

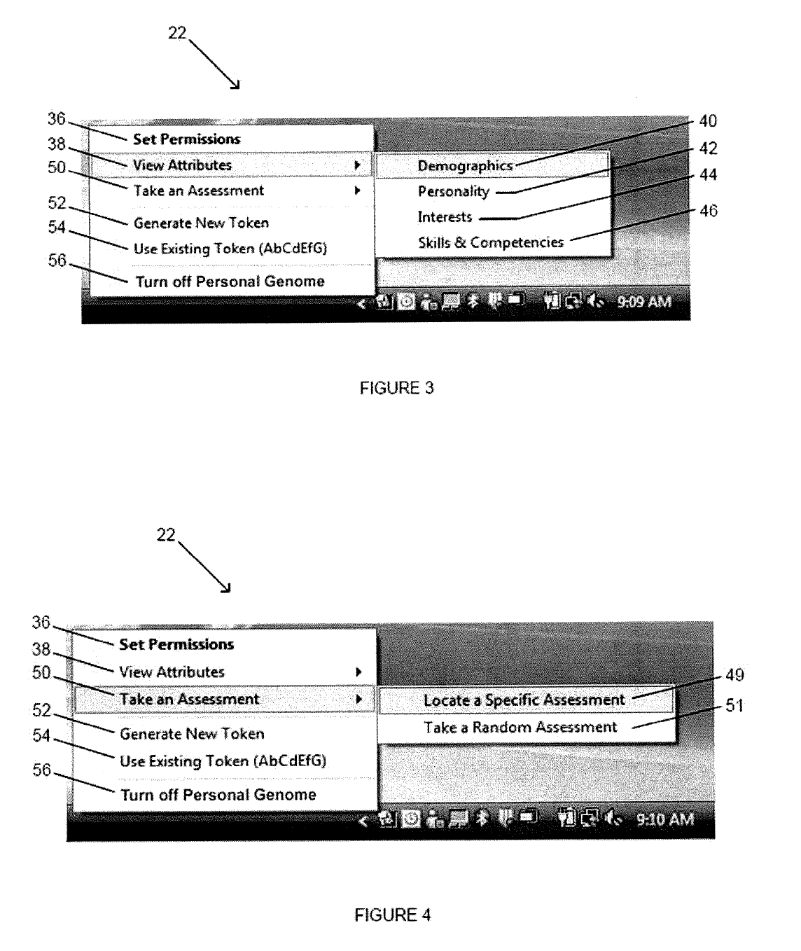

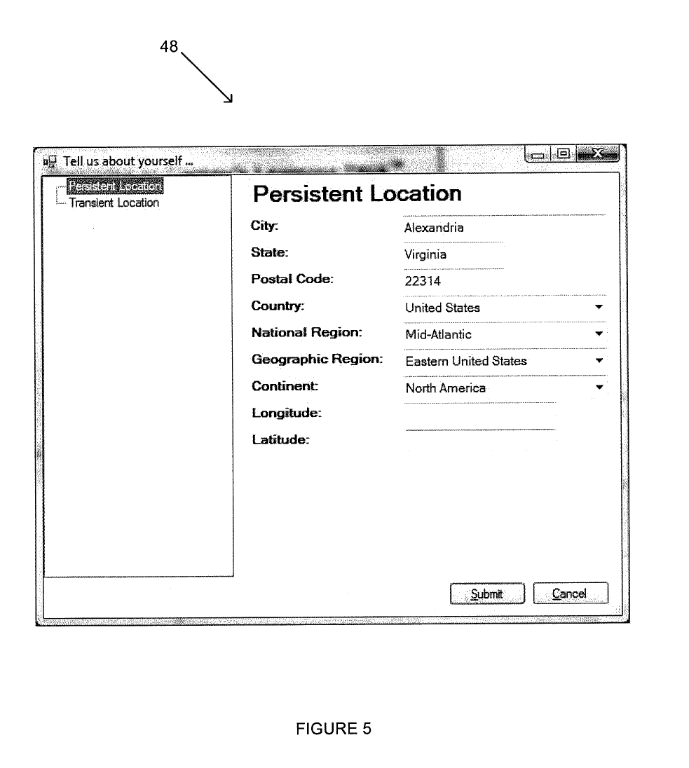

FIGS. 3 and 4 illustrate the client manager 22, according to one embodiment of the invention, on a toolbar of a user's computer. By selecting “set permissions” 36, the user can view and update filtering rules. By selecting “view attributes” 38, the user can view and/or modify or delete attributes in their personal genome. As shown in FIG. 3, the user can view their attributes in categories such as demographics 40, personality 42, interests 44, and skills and competencies 46. For example, FIG. 5 illustrates a data form 48 that can be reviewed and modified by the user after selecting the demographics category from the client manager 22. By selecting “take an assessment” 50 the user can access a random assessment tool 16 (i.e., by selecting “take a random assessment” 49, as shown in FIG. 4) or specific assessment tool 16 (i.e., by selecting “locate a specific assessment” 51, as shown in FIG. 4) to perform or execute. By selecting “generate a new token” 52 the user can request a new temporary pass code to be generated. Generating a new temporary pass code can delete the current temporary pass code, thus stopping any third-party applications 26 using that current temporary pass code from accessing the user's personal genome data, as described in more detail below. By selecting “use existing token” 54, the user can manually provide a temporary pass code on their clipboard for third-party applications 26 to retrieve, as described in more detail below. By selecting “turn off personal genome” 56, the user can disconnect the client manager 22 from the system 10. When the client manager 22 is reconnected to the system 10, a new temporary pass code can be automatically generated so that third-party applications 26 using the old temporary pass code from a previous session before the client manager 22 was disconnected no longer have access to personal genome data.

In some embodiments, the client manager 22 can provide visualization schemes for the user to view certain attributes or categories of attributes. For example, the client manager 22 can display a portion of the user's personal genome 12 in a visual format. The visualization schemes can give the user a simple view of portions of their personal genome 12 so that they can choose which attributes or groups of attributes can be made available to different vendors or third-party applications 26.

The third-party applications 26 can access the user's personal genome data by requesting either raw or aggregated data from the client manager 22, for example, using operating system messages to send and receive data requests and responses. If a third-party application 26 cannot generate or interpret operating system messages, the application 26 can communicate directly to a web service architecture of the system 10 to access the user's personal genome data. In this case, the user 24 can manually request a valid pass code for the application 26. The client manager can provide tools to supply the pass code in this case. Authorized applications 26 can request any number of data fields from the user's personal genome 12, for example through an application programming interface, and the system 10 (e.g., through the central data store 30) can automatically apply various filter rules (e.g., the privacy filter rules and the aggregation filter rules) to the data to ensure that only the data the user 24 wishes to provide are returned to the requesting application 26. The third-party application 26 can connect and communicate with the system 10 in a variety of ways, such as visually, aurally, through radiofrequency identification (RFID), kinesthetically, and/or electronically.

Data in a user's personal genome 12 can be accessed for a variety of different purposes and the data can be updated in a variety of different ways. First, as described above, the user 24 can view and modify their personal genome data through the client manager 22. Second, users 24 can provide information to update data in other users' personal genomes 12 (i.e., other than their own personal genome 12). Third, as described above, third-party applications 26 can access and update personal genome data through assessment instruments 16 executed by the user 24.

Fourth, third-party applications 26 can be sources of user data, such as social networking websites, phone directories, electronic medical records, etc., which may not necessarily use assessment instruments 16 executed by the user 24. The system 10 can communicate with these third-party applications 26 to retrieve such data and update the user's personal genome 12 accordingly. These third-party applications can also already have data appropriately defined, so that the data can be assigned with minimal processing from the advanced competency model 14. In some embodiments, the system 10 can have a searching algorithm to automatically search for these types of third-party applications 26 (e.g., by “crawling” the internet for user data) to constantly update the user's personal genome 12. In these embodiments, the user 24 can be made aware of which third-party applications 26 provided what data. The user 24 can have the option to delete the data in their personal genome 12 and also contact the third-party application 26 to change or delete their saved data if it is incorrect.

Fifth, third-party applications 26 can track a user's transactional history. The system 10 can store the transactional history in the user's personal genome 12 and/or use the user's transactional history to track tendencies, preferences, etc., and update the user's personal genome 12 accordingly. For example, in exchange for a user's personal genome data, a third-party application 26 can provide suggestions (products, travel plans, etc.) for user to purchase. If the user does make a purchase (e.g., makes a transaction), the third-party application 26 can track the transaction and send information related to the transaction to the system 10 so that it can be stored in the user's personal genome 12. In some embodiments, third-party applications 26 can have the capabilities illustrated in one or more of the third, fourth, and fifth examples stated above.

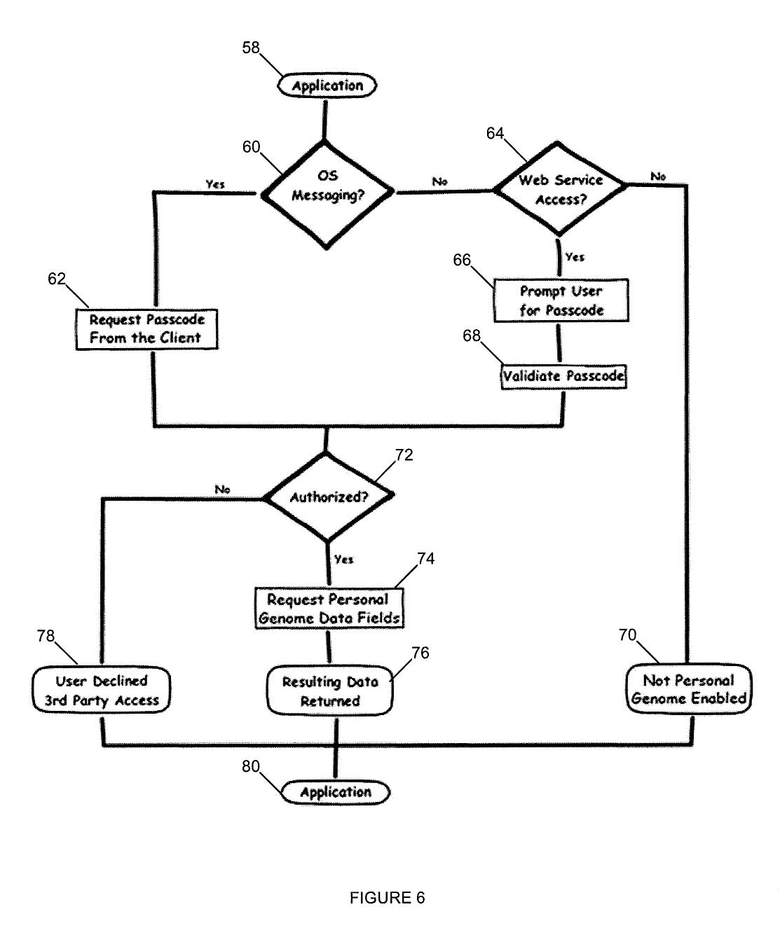

FIG. 6 illustrates a process for third-party application access to personal genome data. The process begins at step 58 when the user 24 launches an application 26 that wishes to adapt its functionality to meet specific circumstances of the user 24. At step 60, the system 10 determines if the application 26 can generate and interpret operating system messages in order to communicate with the system 10 via the client manager 22. If operating system messages are supported, the application 26 can retrieve a valid pass code from the client manager 22 by requesting it at step 62. The client manager 22 is connected with the user's data and a valid pass code can always be ready for applications 26 to use.

If operating system messages are not supported, the application 26 can access the user's personal genome data directly from the system's web service architecture. If the application can access the system's web service, as determined at step 64, the application can manually acquire a valid temporary pass code. The application 26 can request that the user 24 provide a temporary pass code by presenting a data entry field at step 66. The user 24 can then request a copy of a valid temporary pass code to be placed on a system clipboard by the client manager 22. The user 24 can then copy and paste the temporary pass code into the data entry field provided by the application 26 or the application 26 can retrieve the temporary pass code directly from the clipboard. At step 68, the temporary pass code can be sent to the system 10 to verify that it is a valid temporary pass code assigned to the requesting application 26. In some embodiments, the application 26 can communicate with the system's web service architecture via simple object access protocol (SOAP) transactions. If the application 26 cannot use operating system messages, as determined at step 60, and cannot directly access the system's web service, as determined at step 64, the application 26 can be considered “not personal genome enabled” at step 70 and thus cannot access the user's personal genome data.

Once a connection to the system 10 has been established (either through the client manager 22 or directly through the system's web architecture), the user's privacy filters can be invoked to determine whether the application 26, and/or vendor, are authorized to access any of the user's personal genome data at step 72. If the application 26 is authorized to access the user's personal genome data, the application 26 can send a request to retrieve any number of personal genome data fields at step 74. A current directory of all known genome slots can be made available to application developers. Even though the application 26 can request any number of genome data fields, the system 10 can apply a series of aggregation and privacy filter layers to the data, as described above, in order to ensure that the application 26 only receives those data fields and levels of detail that the user wishes to provide. Trusted vendors and applications 26 can receive more detailed data than less-known or less-trusted vendors and applications 26. The resulting filtered data is then returned to the application 26 at step 76.

If the user does not grant access authority to the requesting application 26, as determined at step 72, the system 10 can return an appropriate message indicating that the user has declined to share any information with the application 26 at step 78. A matching message can be stored in the user's privacy filter layer so that the user 24 can see that a request was made and declined. This message can provide a suitable prompt to the user as a reminder in the event that they wish to change their security and privacy settings related to the specific vendor or application 26 that was declined.

If the application 26 is authorized to receive any of the user's personal genome data, the data can be returned as an XML object that can be consumed by the application 26. The application 26 can use the returned data, at step 80, to configure a customized version of a performance enhancement environment 20 and specific assessment instruments 16 to meet the user's circumstances or to construct another, more detailed query based on the information received during the previous request.

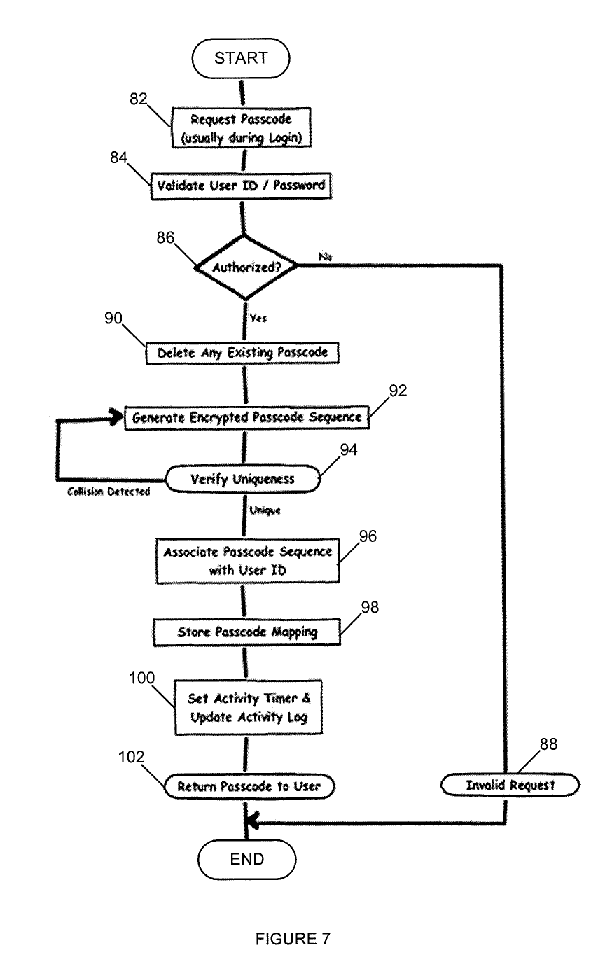

Each time a user 24 needs a valid temporary pass code, it must be generated by the system 10 and associated with the user 24 who requested it. FIG. 7 illustrates a process for pass code to user ID mapping. First, at step 82, the user 24 can request a new temporary pass code via the client manager 22, as described above with respect to FIGS. 3 and 4. This step can occur at any time. In some embodiments, step 82 is performed automatically when the user 24 signs into the system 10 (e.g., when their client manager 22 is launched). Next, at step 84, the system 10 can verify the user's private ID and password before creating the new temporary pass code. The authenticity of the request is then validated at step 86. For example, only requests that originate from a user's client manager software can be authentic. If the request is not valid, an appropriate message can be returned to the user and the any requesting applications 26 at step 88.

If the request is valid, as determined at step 86, any existing temporary pass code associated with the user 24 is deleted at step 90. This can provide an easy method of terminating any active connections to third-party applications 26 that the user 24 no longer wishes to use. Following step 90, a new encrypted temporary pass code can be produced at step 92 to link the user's personal genome data with third-party applications 26. A generation algorithm can be used by the unique pass code system 28 to produce the new temporary pass code. The new temporary pass code is then verified at step 94 to ensure the generation algorithm did not produce a temporary pass code that is already in use. When this collision condition is detected, the system 10 can proceed back to step 92 to receive a new temporary pass code.

The new and verified temporary pass code can then be linked to the user's private ID at step 96 so that subsequent data requests with that temporary pass code can access the user's personal genome data. At step 98, the pass code mapping data is stored (e.g., in a time and activity sensitive data store) for quick reference. Also, a timer and activity data log can be updated at step 100 to make the new temporary pass code link active. The active temporary pass code is then returned to the user's client manager 22 at step 102 where it can be used to authorize third-party applications 26 to access the user's personal genome data.

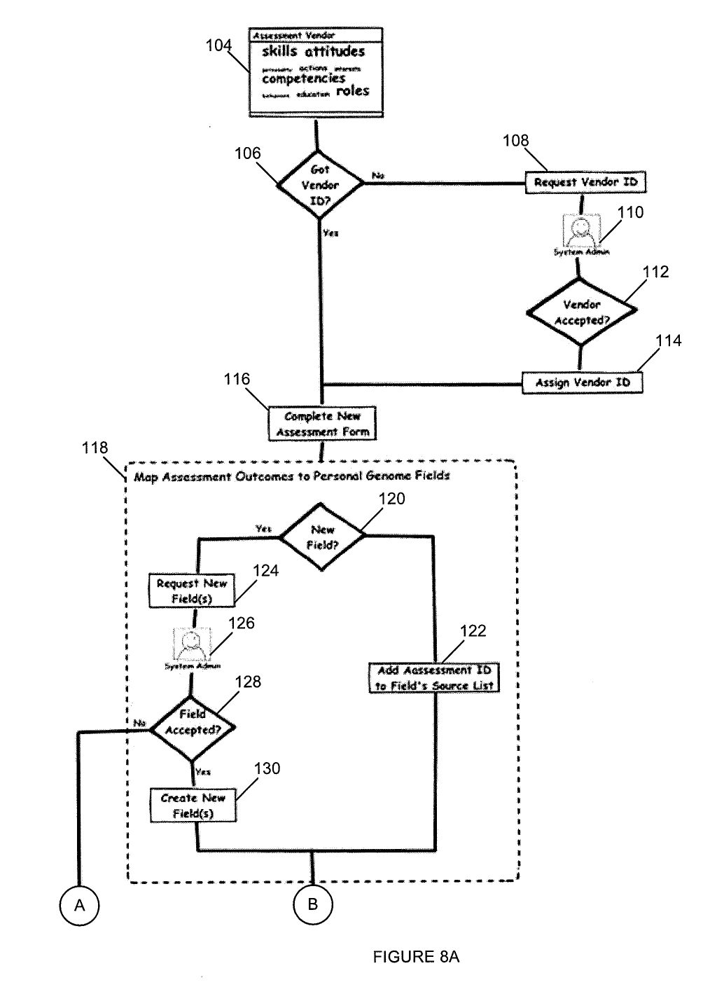

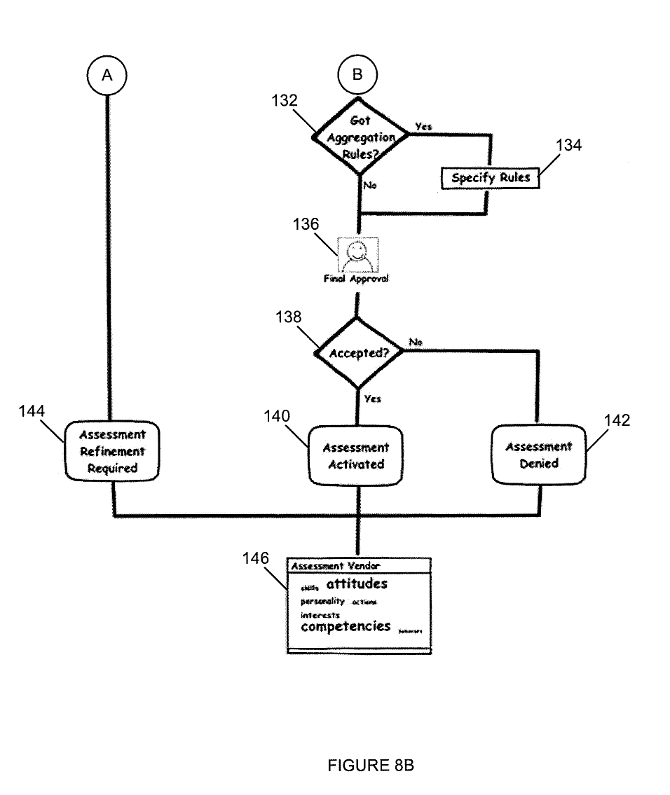

FIGS. 8A-8B illustrate a process to for registering a new assessment instrument 16. As described above, assessment instruments 16 can be used to extend and update the personal genome data structure. The system 10 can incorporate new assessment instruments 16 as soon as they are available to allow new kinds of performance assessment environments 20. New assessment instruments 16 can be registered within the system 10 to describe the types of attributes being assessed and to incorporate the results of the assessment with existing or new genome slots. As soon as an assessment instrument 16 is registered, assessment results can be stored in any user's personal genome 12 and third-party applications 26 can immediately begin to use the new assessment information.

The registration process can begin at step 104 when a third-party application 26 or its associated vendor contacts a vendor support web site operated by the system 10. In some embodiments, all vendors must have a registered vendor ID to participate in the system 10. This vendor ID can be used to provide background information to users 24 who wish to control which vendors can see their personal genome data and can be associated with specific privacy filter rules and aggregation filter rules for the vendor. At step 106, the system 10 can determine if the vendor has a vendor ID. If the vendor does not yet have a vendor ID, one can be requested at step 108 by completing a vendor application form on a vendor support web site operated by the system 10. At step 110, a system administrator can review the vendor's request for completeness and acceptability. The system administrator can accept the vendor's request as is, return it for more information or clarification, or may reject the application out right. If the vendor's request is accepted, as determined at step 112, a unique vendor ID can be issued and stored in the system's central data store 30 at step 114. The vendor ID can be submitted along with every data request so that the system 10 can confirm that the requesting vendor remains in active status and so that user's privacy filters can adequately control the types of data being presented to the vendor.

At step 116, the vendor can complete and submit a new assessment form. Each individual assessment can be defined separately so that the system 10 can determine how the assessment relates to existing genome slots or if new genome slots are appropriate.

Following step 116, a sub process 118 can be performed to map assessment outcomes to personal genome fields or slots. The vendor can provide information about each assessment outcome value and how they think those outcomes relate to the existing genome structure. Since assessments can have more than one outcome, each outcome can be processed separately in an iterative manner. The system 10 can perform the sub process 118 until all outcomes have been processed and mapped. In one embodiment, each outcome is processed concurrently. In addition, in one embodiment, such processing can involve all other slots of the personal genome 12 connected with enabling relations specified in the advanced competency model 14.

First, at step 120, the system 10 determines if the outcome requires a new field or slot. If a new field is not required, the outcome can be added to a list of sources that affect an existing genome field at step 122. If a new field is required, the vendor can request a new field at step 124 and identify the characteristics of the proposed new field so that a new genome slot can be created. A system administrator can review the request for a new genome field at step 126 to ensure that no existing fields can be used to capture the assessment outcome. The system administrator can accept the need for a new genome field, identify existing genome fields that are adequate to capture the assessment outcome, or return the request to the vendor for further clarification at step 128. If the new field request is accepted, the system administrator can create a new genome field at step 130, which can be immediately available in the advanced competency model 14 to all users 24 at the end of the registration process.

Many assessment outcomes can require aggregation rules to be applied in order to present aggregated information to third-party applications 26 without actually handing out the user's raw scores on the assessment. The system 10 can determine if aggregation rules are necessary at step 132. If aggregation rules are to be applied, the vendor and/or the system administrator can load them into the central data store 30 via the system's vendor support web site at step 134. Following step 132 or 134, a final review and approval process can be performed at step 136 to ensure that everything is setup correctly before activating the new assessment instrument 16. At step 138, the assessment instrument 16 can be accepted or the system administrator can deny activation of the assessment instrument 16.

If the assessment is accepted, an assessment ID can be activated at step 140 and outcomes can begin to be captured. If the assessment has been rejected, an appropriate message can be prepared for the vendor at step 142. If refinement is required, as determined at step 128 an appropriate message can be prepared for the vendor at step 144. A final status of the assessment request and any prepared messages are then sent back to the vendor at step 146.

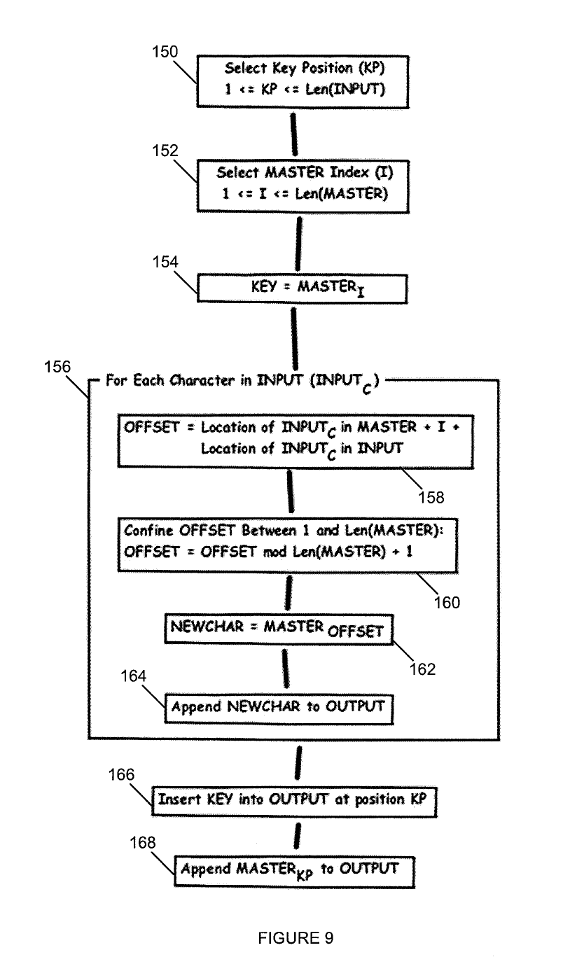

FIG. 9 illustrates a data encryption process used by the system 10 in some embodiments of the invention. The data encryption scheme can be based on the fact that knowledge of the actual keys being used to encode and decode the encrypted strings is not necessary. Each encrypted string can be a self-describing package of data that has been scrambled in a way that is only detectable by algorithms containing the underlying master sequences. These sequences can be generated by a computer and relayed to other computers using steganography techniques that are extremely difficult to detect and decipher.

Each version of the encryption master sequence can be different and independent of previous versions. Furthermore, master sequences can be changed rapidly without human intervention and receiving computers can quickly utilize new master sequences to transform existing encrypted data into new formats each time a new master sequence is received. This can help ensure that all data access is compartmentalized and that accessing the same encrypted data at different times may result in different encrypted strings being generated, even on the same computers. Consequently, even if a master sequence was somehow compromised, the knowledge of that master sequence is only of value until the next time the master sequence changes. The amount of time required to break into a master sequence is likely far greater than the anticipated lifespan of any master sequence.

Given an input string (“INPUT”) and a random set of unique characters (“MASTER”), the system 10 first determines at step 150 where a final key should be stored in the transformed string. Next, at step 152, the system 10 chooses a character position that points to the key for this transformation string. At step 154, the character at that position in the master sequence is retrieved. Following step 154, a sub process 156 is performed, including step 158-164, where each character in the input string is be processed separately in an iterative manner.

At step 158, an offset value (“OFFSET”) can be calculated. More specifically, the system 10 can calculate the position within the master sequence that points to the new transformation character based on the location of the input character (“INPUT_{C}”) within both the input string and the master sequence. Next, at step 160 the system 10 can ensure that the calculated offset is within the bounds of the master sequence. At step 162, the system 10 can use the calculated offset to transform the input character into an encrypted character (“NEWCHAR”). The newly transformed character can then be added to the end of the output string at step 164.

After all input characters have been processed, the previously selected key can be inserted into the previously selected key position within the output string at step 166, and the master sequence character can be added at the key position to the output string at step 168. Following step 168, the input string has been fully transformed into its encrypted version. Additional transformations or alternative encryption schemes can be performed in some embodiments.

In some embodiments, the system 10 can provide different levels of encryption strength based on the user's preference. For example, the user can choose the level of difficulty associated with being able to reconstruct the appropriate access keys or private IDs in the event of a catastrophic failure of the computer hardware devices storing the encryption key. Encryption strength settings can exist on a continuum between automatic regeneration (e.g., lowest strength) and impossible to regenerate (e.g., highest strength, where no human or computer intervention can reconstruct the required encryption key information). In addition, the system 10 can perform debugging and correction of collected data, for example through automatic checking for cross-consistency and cross-sufficiency of collected data.

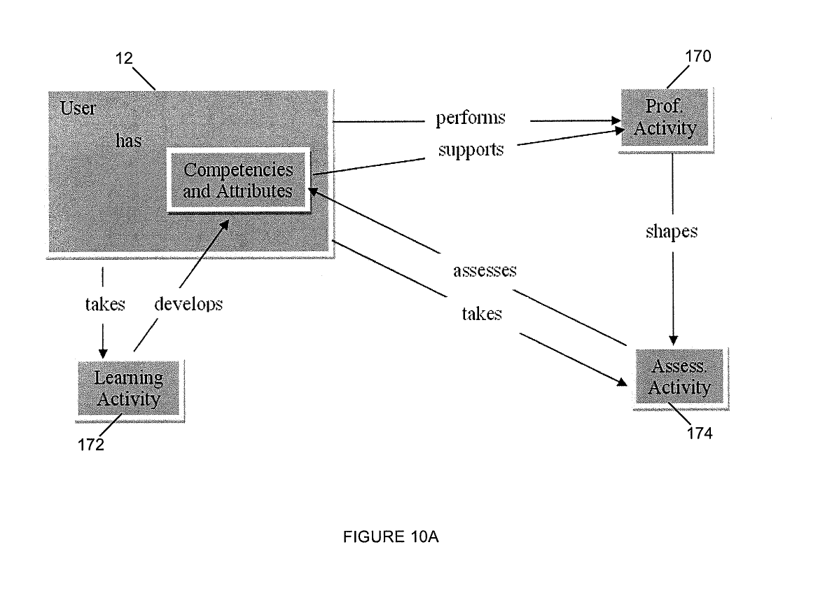

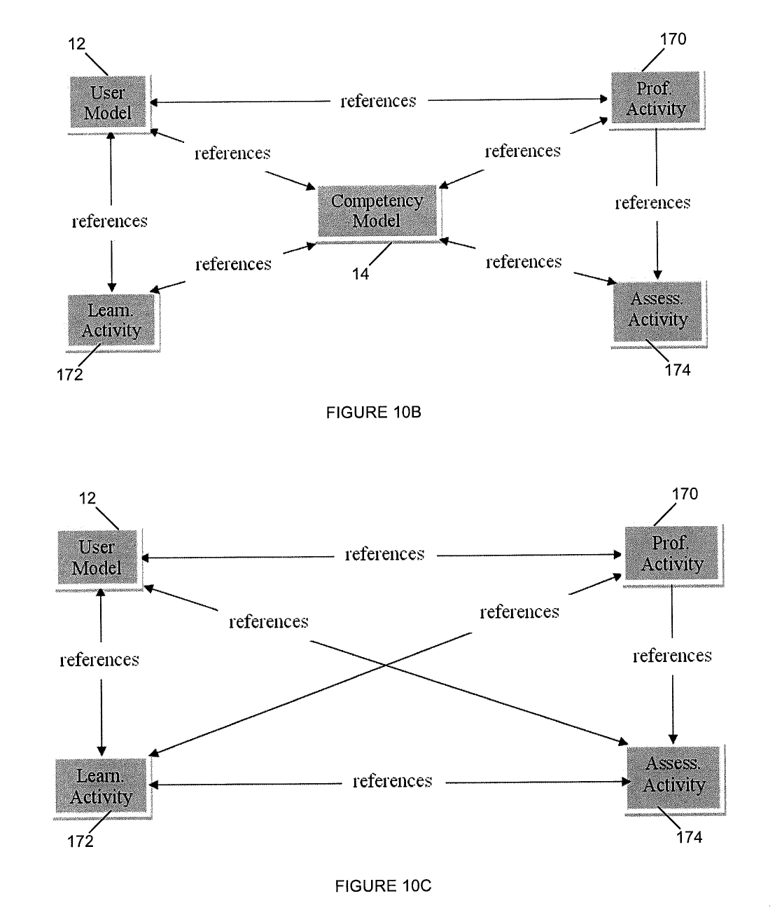

FIG. 10A illustrates an open comprehensive specification for an advanced competency model to correlate competencies, attributes, activities and behaviors of a user in different domains. As shown in FIG. 10A, the specification includes the user's personal genome 12, professional activities 170, learning activities 172, and assessment activities 174. The user's competencies and other attributes to perform professional activities can be stored in the user's personal genome 12. In one embodiment, competency is the ability of a user to perform activities up to a predefined end-result and can be one of many categories of attributes of the user stored in the personal genome, and attributes are personal characteristics of the user, such as interests, beliefs, preferences, psychological, neurological, physiological traits, and abilities, which may somehow influence performance of activities. In one example, competence can be defined (externally) in the context of behavior. In another example, competence can be defined (internally) as a set of sub-competencies, knowledge, skills and attitudes. In yet another example, competence can be defined using both internal and external aspects by referencing behaviors and sub-competencies. Professional activities 170 can be based on a user's competencies and other attributes. Learning activities 172 can develop a user's competencies and other attributes. Assessment activities 174 can measure a user's competencies and other attributes. For example, the professional activities 170, the learning activities 172, and the assessment activities 174 can each be carried out by assessment instruments 16.

FIG. 10B illustrates an advanced competency model 14, according to one embodiment of the invention. As shown in FIG. 10B, the advanced competency model 14 includes references to available provisional activities 170, learning activities 172, and assessment activities 174 to correlate relevant information and provide a complete and detailed representation of the user in corresponding environments together with related competencies and personal attributes.

A traditional widespread correlation for understanding education, learning and training is illustrated in FIG. 10C. As shown in FIG. 10C, all components are inter-connected without an underlying system representing competency and all personal attributes. This incomplete understanding provokes the widespread mal-practice of defining competency as just a successful activity.

The following paragraphs describe different example uses of the system 10 according to some embodiments of the invention. The following examples can be applied singly or in one or more combinations with each other.

In one example, the system 10 can be used to tailor third-party applications 26 in a manner that improves user experiences. The user 24 can have a personal genome 12 storing a number of personal attributes and competencies. The personal genome 12 can track a user's attributes and competencies against defined competency definitions in the advanced competency model 14. The user 24 can then allow for a third-party application 26 to have access to portions of data in their personal genome 12. The third-party application 26 can use competencies defined by the advanced competency model 14 to gain an understanding of the user 24. As a result, when the user 24 launches an assessment instrument 16, the third-party application 26 can make appropriate changes to tailor the assessment instrument 16 specifically for the user 24. For example, the third-party application 26 can react to and present information and tasks in the assessment instrument 16 that are at an appropriate level for a person with the user's personal attributes. The third-party application 26 can also track the user's history when using assessment instruments 26 and submit tendencies, performance, and other data back to the system 10. The advanced competency model 14 can again track the user's tendencies, performance, and other data and update the user's personal genome data.

In some embodiments, the above example is used in teaching applications. Third-party applications 26 can create performance enhancement environments 20 in the form of learning courses. A user's competencies can be accessed by the third-party applications 26 as the user 24 performs different tests (i.e., assessment instruments 16) in the learning courses. Competencies assessed by the third-party applications 26 can be defined by the system 10 and individual slots in the user's personal genome 12 can be created to store the competencies. Output data from the learning courses (scores, assessments, etc.) can be analyzed by the advanced competency model 14, assigned to the corresponding slots in the user's personal genome 12, and later accessed by third-party applications 26 for further testing.

In another example, a third-party application 26 or the system 10 itself can query the system 10 to search a user's personal genome 12 and automatically suggest to the user specific assessments 16 from a performance enhancement environment 20 that target specific data elements that are not currently represented in the user's personal genome 12 or which may have changed since the last time the user 24 was assessed on the specific topic (e.g., due to a long period of inactivity).

Further to the above example, the system 10, either independently or with a third-party application 26, can perform user-authorized internet searches for information related to the user 24. The system 10 can then store such information, alert the user 24 of such available information and the source of such available information, and/or perform other user-authorized tasks such as automatically deleting the user's information from the source or requesting that the information be hidden. For instance, the system 10 can use information from social networking sites to update the user's personal genome data. The user 24 can be given the option (e.g., at system start-up) to authorize the system 10 to search the social networking sites and other websites and update the user's personal genome data accordingly. Also, when the user 24 enters their phone numbers into the client manager 22 for storage into their personal genome 12, they can have the option for the phone numbers to be placed on a global “do not call” list. If authorized by the user, the system 10 can, as a background task, search the internet to ensure the user's phone numbers are not publicly available. In addition, the system 10 can search for users' credit ratings available on the internet through different sources, if authorized by the user. The system 10 can alert the user 24 of the different sources and what credit ratings are made available through each source.

In yet another example, the system 10 can be used to collect and produce detailed human behavior, knowledge, skills, and attitudinal data related to anonymous users suitable for corporate and academic research efforts. The system 10 and/or a third-party application 26 can select specific research populations of users 24 and extract targeted data elements (e.g., raw or aggregated data) from the selected research populations. The users 24 can have the ability to specify which data elements can be extracted, either in their entirety (i.e., as raw data) or in an aggregated form, prior to the data being released for the research efforts. In addition, users can receive monetary payments or in-kind value transactions for releasing their data. Such payments can be tracked and managed by the system 10 or the third-party application 26 receiving and assessing the data.

In another example, a third-party application 26 can interact with the system 10 to act as personal agent to assist a user 24 in making personal and/or professional decisions based upon the content of the user's personal genome 12, the central data store 30, and/or any available third-party information. The application 26 can capture events and knowledge about user's activities and then provide advice and recommend next actions based on the captured knowledge in the fields of learning, education, training, performance and/or job support. The application 26 can further apply intelligence to the personal genome 12, and provide guidance and recommendations to the user 24 based upon the available data in the central data store 30. The system 10 can reference to a competency, a professional activity, and a performance of the professional activity, then provide a mapping relation between the professional activity and the performance and a mapping relation between the performance and the competency (e.g., through the advanced competency model 14). A formal assessment thus can be conducted for the competency based upon the identified performance of the activity. The application 26 can determine a formal rating of the activity, and which expected performance would better improve targeted competency. The application 26 or the system 10 can also provide advice based on inferences determined by the mapping relations.

Further to the example above, a third-party application 26 can interact with the system 10 to act as personal agent to assist a user 24 in making decisions in leisure and everyday activities, such as at a retail store, a museum, a travel website, etc.

In the retail store example, the user can access their client manager 22 on their PDA or smart phone and visualize and decide which information from their personal genome that they want made available to a clothing store (e.g., measurements, shoe size, shirt size, personal style preferences, previous clothing-type transactions, other related transactions, etc.). A third-party application 26 associated with the clothing store can include a scanner or reader and the user's client manager 22 can provide a visual bar code on the user's phone. The visual bar code can include a temporary pass code which can be interpreted by the scanner or reader. The third-party application 26 can then use the temporary pass code to access the personal genome information which was made available by the user 24. The third-party application 26 can then assess the available personal genome information and make suggestions to the user 24 based on the assessment, such as items they may be interested in, specific areas of the clothing store that would include items they may be interested in, sales on items similar to items they have recently purchased, etc. This information can be made available to the user through an application computer (e.g., at a kiosk at the clothing store, which can also include the scanner or reader) or through the user's phone (e.g., the third-party application 26 sends the information directly to the user 24 through an e-mail or SMS message or through the client manager 22). If the user 24 purchases any items at the clothing store, the third-party application 26 can submit the transaction details to the system 10 for updating the user's personal genome data. The user 24 can later view the transaction details and can have the option to delete the details from their personal genome 12.

Retail stores that are “personal genome-enabled” can allow a better shopping experience for users. Users can also enhance their personal genome by shopping at personal genome-enabled retail stores since their transactions can be tracked and added to their personal genome. In addition, because the user's personal genome 12 can store all of the user's information and transaction histories, purchases from one store can be used to improve the user's shopping experience at a different store. For example, a third-party application 26 associated with a book store in a mall can use transactional data from a user's online book purchases as well as purchases from the specific book store to perform a better overall assessment of the user's reading preferences, rather than only using the user's transaction history from the specific book store.

In the museum example, the user can access their client manager 22 on their PDA or smart phone and visualize and decide which information from their personal genome that they want made available to a museum (e.g., education, recent travel history, book preferences, general preferences, etc.). A third-party application 26 associated with the museum can include a scanner or reader and the user's client manager 22 can provide a visual bar code on the user's phone. The visual bar code can include a temporary pass code which can be interpreted by the scanner or reader. The third-party application 26 can then use the temporary pass code to access the personal genome information which was made available by the user 24. The third-party application 26 can then assess the available personal genome information and make suggestions to the user 24 based on the assessment, such as attractions they may be interested in. In addition, the third-party application 26 can act as a virtual museum tour guide to create a tour which can be played on the user's phone or a separate device for an enhanced museum experience tailored to the user's educational background and personal preferences.

In the travel website example, the user 24 can allow for a third-party application 26 associated with a travel website to access portions of their personal genome information (e.g., interests, recent travels, etc.). The third-party application 26 can then assess the user's information and suggest custom travel plans which may be of interest to the user 24. If the user 24 makes a purchase on the travel website, the third-party application 26 can communicate the transaction with the system 10.

In another example, the system 10 itself or the system 10 interacting with a third-party application 26 can act as a global software agent that constructs affinity groups and interpersonal inferences for each subscribing user 24 based upon similar anonymous user information in the central data store 30. The system 10 can provide automatic selection and recommendation of probable items of interest. The system 10 can include a probabilities-based algorithm that anonymously matches similar users 24 to fill gaps in personal genomes 12 based on information stored in the personal genomes 12 for matching users 24. The system 10 can also include a probabilities-based algorithm that recommends actions that will improve users' experiences based on data from similar user and goal-oriented user communities.

Further to the above example, the system 10 can act as a social networking application in addition to interacting with other third-party applications 26. The system 10 can allow users to make certain portions of their personal genome 12 publicly available for other users to view and provide feedback for. Various filters can be applied by the user 24 to their personal genome data so that different users 24 can see differently aggregated data depending on, for example, relationships or connections with the user 24. The system 10 can use the feedback from other users 24 to update the user's personal genome 12, when appropriate. A single feature, or attribute, can be suggested for the user 24 to update their personal genome based on that feature in a similar user's personal genome data (e.g., similar meaning having many similar features, attributes, competencies, etc.). Also, users 24 can be grouped in different classes based on their similarities in certain categories and different suggestions for the same feature can be suggested to the user based on that feature in personal genomes from the same group. These suggestions can improve the scope of the user's personal genome 12, thus providing more detailed information about the user for third-party applications 26.

Further to the above example, when executing assessment instruments 16, users 24 can view a level of completeness of their personal genome 12 (e.g., how many attributes they have stored compared to how many attributes are globally available). The users 24 can also invite other users 24 to execute the same assessment instrument 16 to asses the user 24 or themselves on the same topic.

In yet another example, in addition to including user attributes for assessment instruments, the personal genome 12 can act as a secure global repository for a user's medical records. An application 26 associated with a specific doctor, clinic, or hospital can be permitted access to the user's medical records upon request. Because records from different doctors and clinics can all be stored in one place, there can be less medical error due to misinformed doctors who have not received adequate medical histories and less paperwork has to be sent from doctor to doctor, etc. Also, when a user 24 receives results of a medical test, the doctor (or hospital or clinic) can give the user the option to have the results saved in their personal genome 12. If approved, an application 26 associated with doctor can communicate with the system 10 to input the user's medical results. The advanced competency model 14 can sort incoming medical results into appropriate slots in the user's personal genome 12.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A digital profile system for a user, the system interacting with a third-party application which provides an assessment tool for execution by the user, the system comprising:
a personal genome database which stores a plurality of user attributes, the plurality of user attributes being associated with a private user identifier;
a server processor which executes computer-readable instructions of
an advanced competency model to define and sort the plurality of user attributes to designated slots in the personal genome database,
a unique pass code system to generate a current temporary pass code and link the current temporary pass code to the private user identifier and the plurality of user attributes associated with the private user identifier,
at least one privacy filter to apply data access privileges to the third-party application based on privacy filtering rules controlled by the user; and
a user processor in communication with the server processor, the user processor executing computer-readable instructions of a client manager to receive a request from the third-party application for the current temporary pass code, retrieve and submit the current temporary pass code to the third-party application, receive a request from the third-party application for the plurality of user attributes for adapting the assessment tool specifically for the user, retrieve and submit the plurality of user attributes to the third-party application if allowed by the at least one privacy filter, receive an updated attribute from the third-party application based on the user's performance when executing the assessment tool, and submit the updated attribute to the advanced competency model to define and sort the updated attribute to a designated slot in the personal genome.

2. The system of claim 1 and further comprising the server processor executing computer-readable instructions of at least one data filter to modify at least one of the plurality of user attributes to create a plurality of filtered user attributes based on data filtering rules controlled by the user.

3. The system of claim 1 wherein the plurality of user attributes includes at least one of personal demographics, interests, knowledge, skills competencies, aptitudes, attitudes, and behaviors.

4. The system of claim 1 and further comprising the user processor executing computer-readable instructions of the client manager to provide a user interface for the user to one of view, modify, and delete at least one of the plurality of user attributes and, if the at least one of the plurality of user attributes is modified, submit the user-modified attribute to the advanced competency model to define and sort the user-modified attribute to a designated slot in the personal genome.

5. The system of claim 1 and further comprising the server processor executing computer-readable instructions of at least one chrono-filter to modify at least one of the plurality of user attributes to create a plurality of filtered user attributes based on time-sensitive data filtering rules.

6. The system of claim 1 wherein the current temporary pass code is one of an electronic pass code and a visual pass code.

7. The system of claim 1 wherein the personal genome database stores the plurality of user attributes in an encrypted form based on user-defined encryption strength settings.

8. A method for capturing, storing, and updating information about a user's attributes in a personal genome database in communication with a user computer, the method comprising:
providing a first personalized assessment instrument for execution by the user;
retrieving an outcome of the first personalized assessment instrument executed by the user;
mapping the outcome to at least one attribute of the user;
updating information for the at least one attribute in accordance with the outcome;
storing the information for the at least one attribute in the personal genome database; and
providing the information to an application, when authorized by the user, for creating a second personalized assessment instrument for execution by the user.

9. The method of claim 8 and further comprising providing the information on a user interface of the user computer for the user to one of view, modify, and delete the information.

10. The method of claim 8 and further comprising updating the information for the at least one attribute in accordance with time-sensitive rules.

11. The method of claim 8 and further comprising one of prompting the user for authorization for the application to access the information and retrieving user-defined rules to automatically determine authorization for the application to access the information.

12. The method of claim 8 and further comprising receiving a request from the application for the information, retrieving the information from the personal genome database, and applying filtering rules to the information prior to providing the information to the application.

13. The method of claim 8 and further comprising assessing the personal genome database to determine a second attribute which requires information, providing a third personalized assessment instrument for execution by the user based on the information required, retrieving a outcome of the third personalized assessment instrument executed by the user, mapping the outcome to the second attribute of the user, updating information for the second attribute in accordance with the outcome, and storing the information for the second attribute in the personal genome database.

14. The method of claim 8 and further comprising encrypting the information prior to storing the information for the at least one attribute in the personal genome database, wherein the information is encrypted based on a user-specified encryption strength.

15. The method of claim 8 wherein the step of providing the information to an application, when authorized by the user, for creating a second personalized assessment instrument for execution by the user further includes providing a temporary pass code to the application, wherein the temporary pass code allows the application to temporarily access the personal genome database to retrieve the information.

16. The method of claim 8 and further comprising providing a payment to the user after providing the information to the application.

17. A digital profile system for a user, the system interacting with a third-party application which provides an assessment tool for execution by the user, the system comprising:
a personal genome for storing a plurality of user attributes, the plurality of user attributes being associated with a private user identifier and being modifiable by the user and the third-party application;
an advanced competency model to define and sort the plurality of user attributes to designated slots in the personal genome database;
a unique pass code system to generate a current temporary pass code for the third-party application, the unique pass code system linking the current temporary pass code in a time-sensitive and user-controlled manner to the private user identifier so that the third-party application is capable of accessing the plurality of user attributes associated with the private user identifier to make the assessment tool user-specific; and
at least one filter to aggregate at least one portion of the plurality of user attributes prior to the third-party application's access of the plurality of user attributes.

18. The system of claim 17 wherein the advanced competency model receives outcomes from the assessment tool and maps the outcomes to the plurality of user attributes.

19. The system of claim 17 wherein the at least one filter aggregates the one portion of the plurality of user attributes based on category profiles.

20. The system of claim 17 wherein the plurality of user attributes are further modifiable by additional users and an automatic, probabilities-based algorithm executed by a processor.
